(19) United States
(12) Patent Application Publication
(10) Pub. No.: US 2025/0249421 A1
(43) Pub. Date: Aug. 7, 2025

(54) FLUIDIZED BED REACTOR SYSTEM FOR CATALYTIC CRACKING OF LIGHT HYDROCARBONS

(71) Applicant: Chevron U.S.A. Inc., San Ramon, CA (US)

(72) Inventors: Huping Luo, Moraga, CA (US); Xiaoying Ouyang, Albany, CA (US); Alexander E. Kuperman, Midland, MI (US); Lin Li, San Ramon, CA (US)

(21) Appl. No.: 18/433,086

(22) Filed: Feb. 5, 2024

(51) Int. Cl. B01J 8/38; C10G 11/18

(52) U.S. Cl. CPC B01J 8/388; C10G 11/182; C10G 2300/1025; C10G 2300/4006; C10G 2400/20; C10G 2400/22

(57) ABSTRACT

A fluidized bed reactor system includes a riser configured to receive a light hydrocarbon feed stream and a first regenerated catalyst in a bottom portion of the riser, the riser containing one or more heat sources in the bottom portion to generate a heated light hydrocarbon feed stream and a heated regenerated catalyst, and a reaction chamber in a top portion of the riser in fluid communication with a fluidized bed reactor for cracking the heated light hydrocarbon feed stream in the presence of the heated regenerated catalyst flowing upwards from the bottom portion to produce a product effluent stream comprising hydrogen and spent catalyst comprising coke deposits, and a catalyst regeneration unit operatively connected to the fluidized bed reactor and the riser, the catalyst regeneration unit being configured to receive the spent catalyst flowing downwards and combust the coke deposits to produce a second regenerated catalyst.

### BACKGROUND

The ongoing search for alternatives to crude is increasingly driven by a number of factors. These include diminishing petroleum reserves, higher anticipated energy demands, and heightened concerns over greenhouse gas emissions from sources of non-renewable carbon. In view of its abundance in natural gas reserves, as well as in gas streams obtained from biological sources (biogas), natural gas has become the focus of a number of possible routes for providing liquid hydrocarbons. Natural gas occurs underground and is present as a gas when it comes out of the ground. Natural gas primarily consists of methane (CH₄), and additionally some flammable compounds such as ethane (C₂H₆) and propane (C₃H₈). Accordingly, converting light hydrocarbons such as methane to high value products such as hydrogen, olefins and aromatics has become an attractive option.

### SUMMARY

In accordance with an illustrative embodiment, a continuous process comprises:
flowing, into a bottom portion of a riser in fluid communication with a fluidized bed reactor, a first regenerated catalyst and a first light hydrocarbon feed stream to contact with one or more heat sources to generate a first heated light hydrocarbon feed stream and a first heated regenerated catalyst,
flowing the first heated light hydrocarbon feed stream and the first heated regenerated catalyst upwards from the bottom portion of the riser to a reaction chamber in a top portion of the riser to crack the first heated light hydrocarbon feed stream in the presence of the first heated regenerated catalyst to produce a first product effluent stream comprising hydrogen and spent catalyst comprising coke deposits,
combusting, in a catalyst regeneration unit operatively connected to the fluidized bed reactor, the spent catalyst comprising the coke deposits to produce a second regenerated catalyst, and
flowing, into the bottom portion of the riser, the second regenerated catalyst and a second light hydrocarbon feed stream to contact with the one or more heat sources to generate a second heated light hydrocarbon feed stream and a second heated regenerated catalyst.

In accordance with another illustrative embodiment, a fluidized bed reactor system comprises:
a riser configured to receive a light hydrocarbon feed stream and a first regenerated catalyst in a bottom portion of the riser, the riser containing one or more heat sources in the bottom portion to heat the light hydrocarbon feed stream and the first regenerated catalyst to generate a heated light hydrocarbon feed stream and a heated regenerated catalyst, and a reaction chamber in a top portion of the riser in fluid communication with a fluidized bed reactor for cracking the heated light hydrocarbon feed stream in the presence of the heated regenerated catalyst flowing upwards from the bottom portion to produce a product effluent stream comprising hydrogen and spent catalyst comprising coke deposits, and
a catalyst regeneration unit operatively connected to the fluidized bed reactor and the riser, the catalyst regeneration unit being configured to receive the spent catalyst flowing downwards and combust the coke deposits to produce a second regenerated catalyst for sending to the bottom portion of the riser.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated herein by way of example but not limitation. The principles illustrated in the example embodiments of the drawings can be applied to alternate processes and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements. In the accompanying drawings:

FIG. 1A illustrates a schematic diagram of a fluidized bed reactor system and process for catalytic cracking a heated light hydrocarbon feed stream to produce a product effluent stream comprising hydrogen and spent catalyst, according to an illustrative embodiment.

FIG. 1B illustrates a blown-up schematic diagram of a bottom portion of the riser of the fluidized bed reactor system, according to an illustrative embodiment.

### DETAILED DESCRIPTION

Various illustrative embodiments described herein are directed to fluidized bed reactor systems and processes for catalytic cracking of light hydrocarbons to produce a product effluent stream comprising hydrogen and spent catalyst. The conversion of light hydrocarbons into value added chemicals, materials and fuels offers one alternative to crude.

Direct conversion of light hydrocarbons such as methane can produce higher molecular weight hydrocarbons, such as olefins, alkynes and aromatics (e.g., benzene), as value-added chemicals and at the same time produce hydrogen that can be used to make, for example, fuel. Hydrogen is one of the more important options for future clean energy. However, the desired product selectivity obtained from the catalytic cracking process will depend on the particular type of catalyst as well as reaction condition. In addition, this reaction is highly endothermic and the exact value of the reaction heat will depend on the desired product distribution, such as enthalpy in the range of about 90 KJ/mol of CH₄. It is also an equilibrium limited reaction, and high temperatures are usually required to achieve a CH₄ conversion that would be practical for a commercial application. For example, to be commercially practical, maintaining a reactor at a temperature range of 600° C. to 1200° C. is required.

In addition to the costs associated with such a heat-intensive reaction, the required heat creates other practical challenges. For example, under such temperature conditions, the production of coke or solid carbon in the reactor becomes common, which can negatively affect the yield of valuable products, and can cause plugging of the reactor and catalyst deactivation. Such high temperatures also can require expensive materials for the reactor and can make design of the reactor challenging.

A Fluid Catalytic Cracking (FCC) reactor and regenerator system is typically used in petroleum refineries to convert high-boiling point, high-molecular weight hydrocarbons into such products as gasoline, olefinic gases, and other petroleum products. It usually has a reactor for heavy hydrocarbon conversion reactions, one regenerator to regenerate deactivated catalyst, and conduits to transfer spent/regenerated catalysts between each other. The conventional FCC reactor and regenerator system however are designed to receive a liquid feed (heavy hydrocarbon) under relatively low temperature conditions (e.g., at about 500° C. to 600° C.) in the reactor and the spent catalyst under relatively low temperature conditions (e.g., at about 700° C. to 750° C.) in the regenerator. Thus, the FCC reactor and regenerator system is not designed for the direct light hydrocarbon conversion due to the drastically different reaction conditions.

In view of these challenges, there is a need for solutions that produce hydrogen and value-added chemicals from light hydrocarbons in an FCC reactor and regenerator system. It would therefore be advantageous for the reactor design for this process to have the capability to (1) provide the reaction heat needed to maintain an optimized temperature profile to achieve high conversion, and (2) regenerate and recycle the catalyst being used. It would further be advantageous if such solutions are more energy efficient than existing approaches to produce hydrogen and value-added chemicals.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

A “fresh catalyst” as used herein denotes a catalyst which has not previously been used in a catalytic process.

A “spent catalyst” as used herein denotes a catalyst that has less activity at the same reaction conditions (e.g., temperature, pressure, inlet flows) than the catalyst had when it was originally exposed to the process. This can be due to a number of reasons, several non-limiting examples of causes of catalyst deactivation are coking or carbonaceous material sorption or accumulation, steam or hydrothermal deactivation, metals (and ash) sorption or accumulation, attrition, morphological changes including changes in pore sizes, cation or anion substitution, and/or chemical or compositional changes.

A “regenerated catalyst” as used herein denotes a catalyst that had become spent, as defined above, and was then subjected to a process that increased its activity to a level greater than it had as a spent catalyst. This may involve, for example, reversing transformations or removing contaminants outlined above as possible causes of reduced activity. The regenerated catalyst typically has an activity that is equal to or less than the fresh catalyst activity.

The term “primarily” shall be understood to mean an amount greater than 50%, e.g., 50.01 to 100%, or any range between, e.g., 51 to 95%, 75% to 90%, at least 60%, at least 70%, at least 80%, etc.

The non-limiting illustrative embodiments described herein overcome the drawbacks discussed above by providing a fluidized bed reactor system and processes for catalytic cracking a light hydrocarbon feed stream to, for example, a product stream comprising a C₂ to C₁₀ hydrocarbon product and hydrogen by utilizing at least a fluidized bed reactor, a catalyst regeneration unit and riser. According to the non-limiting illustrative embodiments, the fluidized bed reactor system described herein can be a retrofit of an existing FCC reactor system that is typically used in petroleum refineries to convert high-boiling point, high-molecular weight hydrocarbons into such products as gasoline, olefinic gases, and other petroleum products. In other words, the fluidized bed reactor system described herein according to some embodiment can be a modified version of an existing FCC reactor system that is typically used in petroleum refineries to convert high-boiling point, high-molecular weight hydrocarbons into such products as gasoline, olefinic gases, and other petroleum products. Alternatively, in some embodiments, the fluidized bed reactor system described herein can be built as an original fluidized bed reactor system.

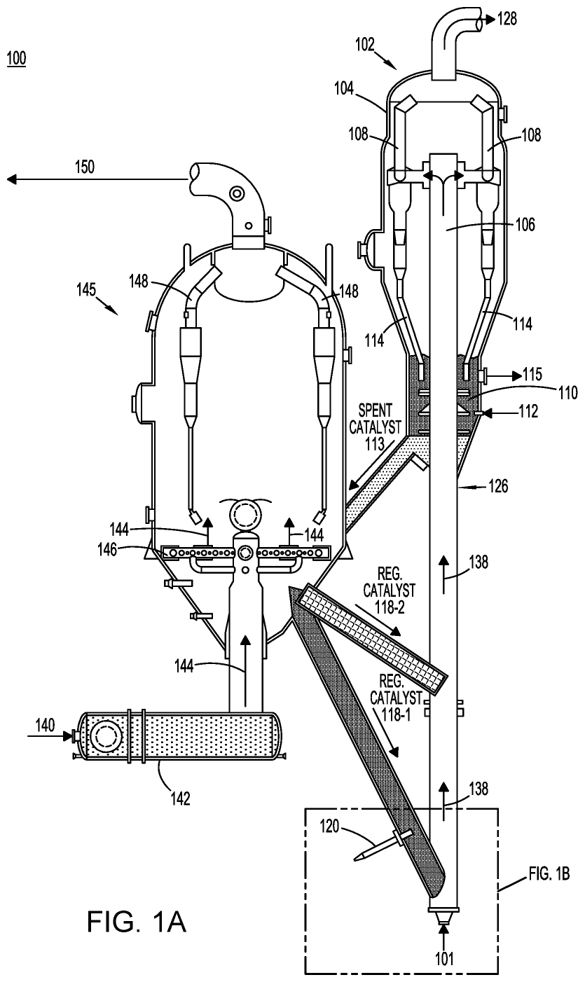

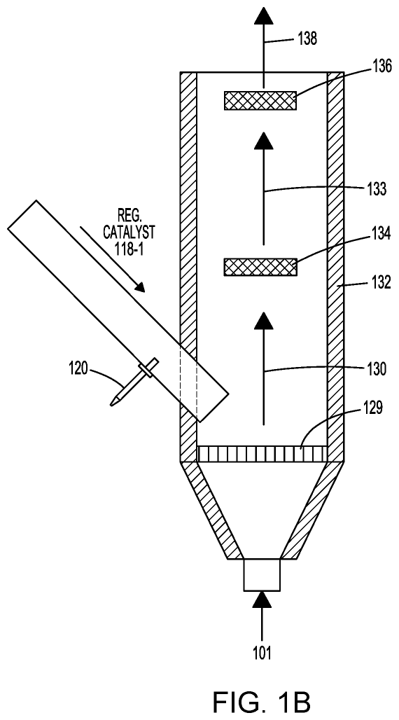

The non-limiting illustrative embodiments of the present disclosure will be specifically described below with reference to the accompanying drawings. For the purpose of clarity, some steps leading up to the production of the product effluent stream comprising a C₂ to C₁₀ hydrocarbon product and hydrogen as well as spent catalyst as illustrated in FIGS. 1A and 1B may be omitted. In other words, one or more well-known processing steps which are not illustrated but are well-known to those of ordinary skill in the art have not been included in the figures. This is not intended to be interpreted as a limitation of any particular embodiment, or illustration, or scope of the claims.

### General Process

The non-limiting illustrative embodiments described herein are directed to a continuous process for catalytic cracking a light hydrocarbon feed stream to produce a product effluent stream comprising hydrogen and spent catalyst utilizing a fluidized bed reactor system. In some embodiments, the continuous process for catalytic cracking a light hydrocarbon feed stream produces a product effluent stream further comprising a C₂ to C₁₀ hydrocarbon product utilizing a fluidized bed reactor system. In non-limiting illustrative embodiments, the process involves flowing, into a bottom portion of a riser in fluid communication with a fluidized bed reactor, a first regenerated catalyst and a first light hydrocarbon feed stream to contact with one or more heat sources to generate a first heated light hydrocarbon feed stream and a first heated regenerated catalyst, flowing the first heated light hydrocarbon feed stream and the first heated regenerated catalyst upwards from the bottom portion of the riser to a reaction chamber in a top portion of the riser to crack the first heated light hydrocarbon feed stream in the presence of the first heated regenerated catalyst to produce a first product effluent stream comprising hydrogen and spent catalyst comprising coke deposits, combusting, in a catalyst regeneration unit operatively connected to the fluidized bed reactor, the spent catalyst comprising the coke deposits to produce a second regenerated catalyst, and flowing, into the bottom portion of the riser, the second regenerated catalyst and the second light hydrocarbon feed stream to contact with the one or more heat sources to generate a second heated light hydrocarbon feed stream and a second heated regenerated catalyst.

The light hydrocarbon feed stream to be employed is not particularly limited and may include, for example, C₁ to C₆ or C₁ to C₄ or C₁ to C₃ or C₁ to C₂ alkanes such as methane, ethane, or natural gas either pure or in any suitable mixture. In some embodiments, the light hydrocarbon feed stream may also contain minor amounts of other ingredients including, for example, carbon dioxide, sulfur compounds such as H₂S, water, nitrogen, and mixtures thereof. In some embodiments the light hydrocarbon feed stream may also include steam, superheated steam, an inert gas such as nitrogen, or any mixture thereof. In some embodiments, the light hydrocarbon feed stream to be employed may include any suitable composition such that the resulting product includes at least hydrogen.

In some embodiments, the light hydrocarbon feed stream comprises methane or natural gas such as, for example, a light hydrocarbon feed stream comprising greater than about 80%, or greater than about 90%, or greater than about 95%, or greater than about 99% methane. As used herein, natural gas comprises methane and potentially higher alkanes, carbon dioxide, nitrogen or other gases, and/or sulfur-containing compounds such as hydrogen sulfide, and mixtures thereof. In illustrative embodiments, the light hydrocarbon feed stream may further contain a portion of the produced products that are recycled back to the light hydrocarbon feed stream along with unreacted methane.

The produced product derived from the light hydrocarbon feed stream typically comprises a C₂ to C₁₀ hydrocarbon product and hydrogen. The C₂ to C₁₀ hydrocarbon product is not particularly limited and can be, for example, saturated, unsaturated, aromatic, or a mixture of such compounds. Examples of aromatic hydrocarbons include benzene, toluene, xylene, naphthalene, and methylnaphthalene. In some embodiments the C₂ to C₁₀ hydrocarbon product may comprise ethylene, propylene, acetylene, benzene, naphthalene, and various mixtures thereof depending upon the desired products and reactions used. In addition, as one skilled in the art will readily appreciate, the resulting C₂ to C₁₀ hydrocarbon product can be one of a liquid hydrocarbon product, a gaseous hydrocarbon product, a solid hydrocarbon product and combinations thereof depending on the particular methane conversion process.

As will be discussed below, the light hydrocarbon feed stream and regenerated catalyst are heated in a bottom portion of the riser utilizing one or more heat sources to generate a heated light hydrocarbon feed stream and a heated regenerated catalyst. The heated light hydrocarbon feed stream and heated regenerated catalyst flow upwards to a reaction chamber in a top portion of the riser in fluid communication with a fluidized bed reactor at a temperature sufficient to crack the heated light hydrocarbon feed stream in the presence of the heated regenerated catalyst to produce a product effluent stream comprising hydrogen and spent catalyst comprising coke deposits. Suitable reaction conditions may vary depending upon the reactants, desired products, catalysts, and equipment employed. In illustrative embodiments, a suitable temperature for the heated light hydrocarbon feed stream can be from about 600° C., or from about 700° C., and up to about 1000° C. or up to about 1200° C. In some embodiments, the reaction can take place at a pressure of from about 1 atmosphere up to about 3 atmospheres, or up to about 5 atmospheres, or up to about 10 atmospheres.

### Catalyst

In an illustrative embodiment, as may be combined with one or more of the preceding paragraphs, the heated regenerated catalyst is circulated through the fluidized bed reactor system in a continuous manner between catalytic cracking reaction and regeneration while continuously maintaining a heated regenerated catalyst in the reaction chamber of the riser. In an illustrative embodiment, as may be combined with one or more of the preceding paragraphs, the regenerated catalyst for use in the illustrative embodiments described herein can be a metal oxide catalyst on an oxide support. Suitable metals of the metal oxide include, for example, Na, K, Mg, Ca, Sr, Cr, Mo, Mn, Fe, Co, Ni, Cu, Zn, Al, rare earth metals, or a mixture thereof. In an illustrative embodiment, the metal oxide can be present in an amount ranging from about 0.1 to about 10 wt. %. In an illustrative embodiment, a suitable oxide support can be any suitable inorganic oxide support. Representative examples of such suitable oxide supports include, but are not limited to, alumina, silica, silica-alumina, titania, zirconia, or a mixture thereof. In one embodiment, the oxide support is one of alumina and silica-alumina where the silica content of the silica-alumina support can range from about 2 to about 30 wt. %. The alumina can be any of the aluminas conventionally used for hydroprocessing catalysts. Such aluminas are generally porous amorphous alumina having an average pore size from about 50 to about 200 angstroms.

The metal oxide catalyst may be in any of the commonly used catalyst shapes such as, for example, spheres, granules, pellets, chips, rings, extrudates, or powders that are well-known in the art.

In an illustrative embodiment, as may be combined with one or more of the preceding paragraphs, the catalyst used herein can be a small particulate catalyst. The term “small particulate catalyst” as used herein shall be understood to mean a catalyst having an average particle diameter of about 0.01 to about 4 millimeters (mm), or about 0.02 to about 1 mm, or about 0.05 to about 0.5 mm or even around 100 micrometers. Any of the lower limits described above can be combined with any of the upper limits.

In an illustrative embodiment, as may be combined with one or more of the preceding paragraphs, the catalyst used herein can be a large particulate catalyst. The term “large particulate catalyst” as used herein shall be understood to mean a catalyst having an average particle diameter of about 0.05 to about 10 mm, or about 0.1 to about 5 mm, or about 0.2 to about 2 mm. Any of the lower limits described above can be combined with any of the upper limits.

### Reactor Systems

Referring now to the drawings in more detail, FIGS. 1A and 1B illustrate a fluidized bed reactor system 100 including at least a fluidized bed reactor 102, a riser 126 and a catalyst regeneration unit 145. It is to be understood that fluidized bed reactor system 100 including at least fluidized bed reactor 102, riser 126 and catalyst regeneration unit 145 are not limited to the configuration of the embodiments shown in FIGS. 1A and 1B, and other configurations are contemplated herein.

Fluidized bed reactor system 100 includes fluidized bed reactor 102 having a reactor wall 104. In a non-limiting illustrative embodiment, fluidized bed reactor 102 may have a cylindrical configuration with a constant diameter along all or a portion of its length of reactor wall 104, which may constitute a majority of its length. In some embodiments, fluidized bed reactor 102 may have a cylindrical configuration from a top of fluidized bed reactor 102 to a bottom of fluidized bed reactor 102 with a uniform diameter. However, as one skilled in the art will appreciate, the cylindrical configurations are merely illustrative and any other suitable shape of the same or varying diameters are contemplated herein.

In illustrative embodiments, fluidized bed reactor 102 includes reactor wall 104 that surrounds the interior. In some embodiments, reactor wall 104 may be formed from a reactor lining having one or more layers of a refractory material that line the interior of reactor wall 104 to reduce heat loss and sustain the high temperatures of fluidized bed reactor 102. The reactor lining provides thermal and abrasion resistance, and may extend over all or a portion of each of the components of fluidized bed reactor system 100 including at least fluidized bed reactor 102, riser 126 and catalyst regeneration unit 145. For example, fluidized bed reactor 102 may operate at high or even extremely high temperatures, and further includes a flowing heated regenerated catalyst and heated light hydrocarbon feed stream 138. These and other factors can lead to, for example, a highly corrosive and erosive environment. Also, minimizing heat losses, minimizing side wall temperatures, and maintaining a desired temperature in a reaction chamber 106 of riser 126 can be important for operational reasons. In addition, using the refractory lining significantly reduces the temperature of reactor wall 104, therefore allowing the use of relatively less expensive alloy to build the fluidized bed reactor 102 as well as the other components of fluidized bed reactor system 100 that have the refractory lining with significant economic benefits. The reactor lining is useful to address these and other considerations.

In some embodiments, the entire reactor lining, or at least significant portions of it, is continuous. As used herein, the term continuous is intended to broadly refer to a condition of being substantially free from seams or other breakages in construction. In some embodiments, the reactor lining has an interior surface that is generally parallel with reactor wall 104. In some embodiments, the reactor lining can go around the entire surface of fluidized bed reactor system 100 including fluidized bed reactor 102, riser 126 and catalyst regeneration unit 145. In some embodiments, the reactor lining can have a thickness which will vary with the particular application and other factors, but in many applications will be between about 1 inch and about 12 inches. In some embodiments, the reactor lining can have a thickness between about 3 inches and about 8 inches.

Suitable materials for use as the refractory material are those that provide good thermal insulation and abrasion resistance. In some embodiments, the reactor lining is castable. A wide variety of suitable refractory materials are known including, for example, standard Portland cement. As one skilled in the art will appreciate, the refractory materials can be inorganic, nonmetallic, porous and heterogeneous materials comprising thermally stable mineral aggregates, a binder phase and one or more additives. In some embodiments, the refractory material may comprise one or more of silica, alumina, calcium oxide, titanium oxide, iron oxide, magnesium oxide, zirconium and others. Different compositions can be selected for different applications, with design considerations including degree of thermal and abrasion resistance needed. Examples include higher abrasion resistant refractory materials in sections of the lining that may be subject to significant abrasion. As one skilled in the art will readily appreciate, different refractory material and its thickness may apply at different locations based on the temperature, turbulence intensity, erosion tendency, etc.

Fluidized bed reactor 102 further includes separators 108 located at the top of fluidized bed reactor 102. Separators 108 receive the product effluent stream comprising hydrogen and spent catalyst comprising coke deposits produced from cracking the heated light hydrocarbon feed stream in the presence of the heated regenerated catalyst. Separators 108 then separate a spent catalyst 113 from the product effluent stream to generate a product stream comprising hydrogen which then exits fluidized bed reactor 102 via line 128. Spent catalyst 113 then flows downward from separators 108 and to a reactor stripper 110 through conduits 114. In some embodiments, spent catalyst 113 flows downward by, for example, gravity forces.

In some embodiments, a suitable separator for use herein includes, for example, a cyclone. Although two separators are shown for separators 108 in FIG. 1A, the number of separators is merely illustrative and any number higher or lower can be used in fluidized bed reactor 102 based on such factors as, for example, reactor design, etc.

Fluidized bed reactor system 100 further includes catalyst regeneration unit 145 for receiving spent catalyst 113 from reactor stripper 110 which is in fluid communication with fluidized bed reactor 102 and riser 126. As discussed above, coke is formed on the surface of spent catalyst 113 comprising the catalyst and coke deposits. Spent catalyst 113 is continuously introduced to catalyst regeneration unit 145 via reactor stripper 110 where spent catalyst 113 is subjected to coke burning conditions to burn most, if not all, of the coke from spent catalyst 113 and provide a regenerated catalyst, which can be split into a regenerated catalyst 118-1 and an optional regenerated catalyst 118-2.

In illustrative embodiments, catalyst regeneration unit 145 includes a reactor wall that surrounds the interior. As discussed above, in some embodiments, the reactor wall may be formed from a reactor lining having one or more layers of a refractory material that line the interior of the reactor wall to reduce heat loss and sustain the high temperatures of catalyst regeneration unit 145. The reactor lining can be the same or of similar material as discussed above for reactor wall 104.

In an illustrative embodiment, catalyst regeneration unit 145 includes a regeneration gas inlet adapted to receive an oxidizing stream 140 into catalyst regeneration unit 145. The regeneration gas inlet may be disposed at the bottom of catalyst regeneration unit 145. However, this is merely illustrative and other locations for the regeneration gas inlet are contemplated herein. Oxidizing stream 140 enters catalyst regeneration unit 145 through heating unit 142 to generate a heated oxidizing stream 144. Oxidizing stream 140 can contain, for example, air, oxygen, nitrogen, methane or combinations thereof or a steam/air mixture.

Heating unit 142 can be any conventional heating unit known in the art that is configured to heat oxidizing stream 140 to generate heated oxidizing stream 144 having a temperature sufficient to combust spent catalyst 113 and produce the regenerated catalyst.

In some embodiments, heating unit 142 is an air heater, which may include a resistive or inductive heating element configured to heat oxidizing stream 140 to generate heated oxidizing stream 144. In some embodiments, heating unit 142 is a steam heater, and may include a heating element, such as a resistive or inductive heating element configured to heat oxidizing stream 140 to generate heated oxidizing stream 144. In some embodiments, heating unit 142 may include a heat exchanger configured to heat the steam using heat extracted from a high-temperature fluid, such as a fluid heated to about 1200° C. or more. This fluid may be provided from a solar concentrator farm or a power plant.

Catalyst regeneration unit 145 further includes a flow distributor 146 which is configured to inject heated oxidizing stream 144 amongst spent catalyst 113 disposed in catalyst regeneration unit 145. The coke can be burned from spent catalyst 113 by exposing spent catalyst 113 to heated oxidizing stream 144 at appropriate high temperature and time duration conditions to burn off and remove substantially all coke deposits from the catalyst. In an illustrative embodiment, a temperature can range from about 450° C. to about 1400° C., and a time period can range from about 10 minutes to about 600 minutes. Accordingly, regenerating spent catalyst 113 generally comprises combustion of spent catalyst 113 in an oxidizing atmosphere to burn the coke deposits and redisperse active metal on the catalyst particles. Burning the coke is an exothermic process that can supply the heat needed for the reaction process. In a heat balanced operation, the quantity of coke formed on the catalyst is significant enough that no external heat source or fuel is needed to supplement the heat from coke combustion.

In some embodiments, catalyst regeneration unit 145 is operated as a moving bed with spent catalyst 113 continuously moving downwards. In some embodiments, catalyst regeneration unit 145 is operated as a fluidized bed.

The coke burn causes the spent catalyst to be heated to an elevated temperature, e.g., a temperature of from about 450° C. to about 1400° C., to provide a heated regenerated catalyst relatively free or free of coke wherein the catalyst particles are heated, and sent to riser 126. The coke burn also generates a flue gas which will pass through a series of separators 148, where the solid particulates carried over in the flue gas are separated and drained back down to the lower section of catalyst regeneration unit 145 and generate a flue gas stream 150 free of particulates exiting through a top portion of catalyst regeneration unit 145. In some embodiments, flue gas stream 150 is composed of, for example, carbon dioxide and nitrogen. In some embodiments, separators 148 are a series of cyclones. In some embodiments, the series of cyclones are configured in two or more stages such that the gas effluent from the first stage enters the second stage to increase the efficiency of particulate removal.

In addition, heated oxidizing stream 144 is used to fluidize the regenerated catalyst in catalyst regeneration unit 145. The regenerated catalyst is continuously introduced to riser 126 at an elevated temperature relative to the temperature of the spent catalyst. The heat generated by the coke burn in catalyst regeneration unit 145 is continuously transferred with the regenerated catalyst to riser 126.

In some embodiments, catalyst regeneration unit 145 may further have one or multiple conduits between catalyst regeneration unit 145 and different locations in riser 126 that allows the heated regenerated catalyst to be transferred to different locations of riser 126. For example, the regenerated catalyst can be split into two or more streams such as regenerated catalyst 118-1 and regenerated catalyst 118-2. In some embodiments, regenerated catalyst 118-1 or regenerated catalyst 118-2 can have a temperature ranging from about 600° C. to about 1500° C. In some embodiments, the one or multiple conduits can have valves to adjust the regenerated catalyst flow. For example, the flow of regenerated catalyst 118-1 can be controlled by adjusting valve 120. In some embodiments, regenerated catalyst 118-1 is introduced through a first conduit in a bottom portion of riser 126 where it is contacted with light hydrocarbon feed stream 101 as discussed below, and regenerated catalyst 118-2 enters through a second conduit located upwards of the first conduit and flows upwards with the heated regenerated catalyst and heated light hydrocarbon feed stream 138 as discussed below.

Fluidized bed reactor system 100 includes riser 126 for receiving regenerated catalyst 118-1 and optionally regenerated catalyst 118-2 from catalyst regeneration unit 145.

In some embodiments, riser 126 has a first diameter and fluidized bed reactor 102 has a second diameter greater than the first diameter. By riser 126 having a smaller diameter than fluidized bed reactor 102, regenerated catalyst 118-1 and regenerated catalyst 118-2 can be substantially or fully fluidized when contacting with the light hydrocarbon feed stream 101 to carry out the direct light hydrocarbon conversion reactions.

Riser 126 further receives light hydrocarbon feed stream 101 through an inlet in the bottom portion of riser 126. In some embodiments, light hydrocarbon feed stream 101 is at or near room temperature. As shown in FIG. 1B, light hydrocarbon feed stream 101 enters through an inlet in the bottom portion of riser 126 having a reactor wall 132. The light hydrocarbon feed stream 101 then flows upward utilizing flow distributor 129 where it is combined with regenerated catalyst 118-1 to form a regenerated catalyst and light hydrocarbon feed stream 130. The flow of regenerated catalyst 118-1 is controlled by valve 120 as discussed above. In a non-limiting illustrative embodiment, riser 126 may have a cylindrical configuration with a constant diameter along all or a portion of its length of reactor wall 132, which may constitute a majority of its length. In some embodiments, riser 126 may have a cylindrical configuration from a top of riser 126 to a bottom of riser 126 with a uniform diameter. However, as one skilled in the art will appreciate, the cylindrical configurations are merely illustrative and any other suitable shape of the same or varying diameters are contemplated herein.

In illustrative embodiments, riser 126 includes reactor wall 132 that surrounds the interior. As discussed above, in some embodiments, reactor wall 132 may be formed from a reactor lining having one or more layers of a refractory material that line the interior of reactor wall 132 to reduce heat loss and sustain the high temperatures of riser 126. The reactor lining can be the same or of similar material as discussed above for reactor wall 104.

Regenerated catalyst and light hydrocarbon feed stream 130 flows upwards where it can first be contacted with a heat source 134 to generate a first heated regenerated catalyst and first heated light hydrocarbon feed stream 133. Heat source 134 can be any suitable heat source capable of heating regenerated catalyst and light hydrocarbon feed stream 130 to a sufficient temperature to crack the light hydrocarbon feed stream in reaction chamber 106 of riser 126. In some embodiments, heat source 134 can be any conventional heating unit known in the art. For example, in some embodiments, heat source 134 may include a heating element, such as a resistive or inductive heating element. In some embodiments, heat source 134 may include a heat exchanger configured to heat regenerated catalyst and light hydrocarbon feed stream 130 using heat extracted from a high-temperature fluid, such as a fluid heated to about 600° C. or more. This fluid may be provided from a solar concentrator farm or a power plant. In some embodiments, heat source 134 can be tail gas or other low value fuel gas received through an inlet in riser 126 which can be from the plant where the fluidized bed reactor system 100 is located or any other suitable sources can be used as the fuel. In some embodiments, heat source 134 can be preheated air or concentrated oxygen received through an inlet in riser 126 and can be used as the oxidant. In some embodiments, heat source 134 is configured to heat regenerated catalyst and light hydrocarbon feed stream 130 to a temperature ranging from about 600° C. to about 1200° C. to generate a first heated regenerated catalyst and first heated light hydrocarbon feed stream 133. In some embodiments, heat source 134 is configured to heat regenerated catalyst and light hydrocarbon feed stream 130 to a temperature below a temperature sufficient to crack the light hydrocarbon feed stream in generating first heated regenerated catalyst and first heated light hydrocarbon feed stream 133.

In some embodiments, when the temperature of first heated regenerated catalyst and first heated light hydrocarbon feed stream 133 is not sufficient to crack the light hydrocarbon feed stream then first heated regenerated catalyst and first heated light hydrocarbon feed stream 133 flows upwards where it can be further contacted with a heat source 136 to generate a second heated regenerated catalyst and heated light hydrocarbon feed stream 138 (i.e., a second heated regenerated catalyst and a second heated light hydrocarbon feed stream) having a temperature greater than the temperature of first heated regenerated catalyst and first heated light hydrocarbon feed stream 133. Heat source 136 can be any suitable heat source as described above for heat source 134. Heat source 136 is configured to heat first heated regenerated catalyst and first heated light hydrocarbon feed stream 133 to a temperature ranging from about 600 to about 1200° C. to generate second heated regenerated catalyst and heated light hydrocarbon feed stream 138.

As one skilled in the art will readily appreciate, although two heat sources are shown in the FIG. 1B any number of heat sources are contemplated in order to provide extra heat source for the highly endothermic reactions.

Turning back to FIG. 1A, second heated regenerated catalyst and heated light hydrocarbon feed stream 138 flows upward in riser 126 where it is continuously sent to reaction chamber 106. In some embodiments, it may be necessary to add additional catalyst to second heated regenerated catalyst and heated light hydrocarbon feed stream 138. Thus, in some embodiments, regenerated catalyst 118-2 flows into riser 126 and is combined with second heated regenerated catalyst and heated light hydrocarbon feed stream 138. Second heated regenerated catalyst and heated light hydrocarbon feed stream 138 and regenerated catalyst 118-2 flow upwards to reaction chamber 106 where second heated regenerated catalyst and heated light hydrocarbon feed stream 138 are subjected to cracking.

In illustrative embodiments, second heated regenerated catalyst and heated light hydrocarbon feed stream 138 are subjected to reaction conditions such as, for example, a temperature of from about 600° C. to about 1200° C., and for a residence time of second heated regenerated catalyst and heated light hydrocarbon feed stream 138 in fluidized bed reactor 102 of from about 0.05 seconds to about 100 seconds, or from about 0.1 seconds to about 2 seconds.

In some embodiments, riser 126 is operatively connected to separators 108 of fluidized bed reactor 102. Accordingly, once second heated regenerated catalyst and heated light hydrocarbon feed stream 138 has been cracked, the product comprising a C₂ to C₁₀ hydrocarbon product and hydrogen (i.e., cracked products) can be sent to separators 108 (cyclones) where the spent catalyst comprising coke deposits as well as unstripped hydrocarbon can be separated from the product comprising a C₂ to C₁₀ hydrocarbon product and hydrogen. The separated product comprising a C₂ to C₁₀ hydrocarbon product and hydrogen can then exit fluidized bed reactor 102 via line 128. Spent catalyst and unstripped hydrocarbons will fall to reactor stripper 110. In some embodiments, a steam stream 112 can be introduced into reactor stripper 110 to assist in separating spent catalyst 113 from unstripped hydrocarbons to generate separated unstripped hydrocarbons and spent catalyst 113. The separated unstripped hydrocarbons can then exit reactor stripper 110 as a stream 115. Spent catalyst 113 is continuously introduced into catalyst regeneration unit 145 as discussed above.

According to an aspect of the invention, a continuous process comprises:
flowing, into a bottom portion of a riser in fluid communication with a fluidized bed reactor, a first regenerated catalyst and a first light hydrocarbon feed stream to contact with one or more heat sources to generate a first heated light hydrocarbon feed stream and a first heated regenerated catalyst,
flowing the first heated light hydrocarbon feed stream and the first heated regenerated catalyst upwards from the bottom portion of the riser to a reaction chamber in a top portion of the riser to crack the first heated light hydrocarbon feed stream in the presence of the first heated regenerated catalyst to produce a first product effluent stream comprising hydrogen and spent catalyst comprising coke deposits,
combusting, in a catalyst regeneration unit operatively connected to the fluidized bed reactor, the spent catalyst comprising the coke deposits to produce a second regenerated catalyst, and
flowing, into the bottom portion of the riser, the second regenerated catalyst and a second light hydrocarbon feed stream to contact with the one or more heat sources to generate a second heated light hydrocarbon feed stream and a second heated regenerated catalyst.

In one or more additional non-limiting illustrative embodiments, as may be combined with one or more of the preceding paragraphs, flowing the first heated light hydrocarbon feed stream and the first heated regenerated catalyst upwards from the bottom portion of the riser in fluid communication with the fluidized bed reactor to the reaction chamber in the top portion of the riser utilizes a flow distributor.

In one or more additional non-limiting illustrative embodiments, as may be combined with one or more of the preceding paragraphs, the riser is operatively connected to one or more separators in the fluidized bed reactor and the first product effluent stream comprising hydrogen and spent catalyst comprising coke deposits are sent from the reaction chamber of the riser to the one or more separators.

In one or more additional non-limiting illustrative embodiments, as may be combined with one or more of the preceding paragraphs, cracking the first heated light hydrocarbon feed stream in the presence of the first heated regenerated catalyst further produces unstripped hydrocarbons; and the process further comprises:
separating the first product effluent stream comprising hydrogen, the spent catalyst comprising coke deposits and the unstripped hydrocarbons in the separator,
flowing the spent catalyst comprising coke deposits and unstripped hydrocarbons downwards to a reaction stripper of the fluidized bed reactor,
stripping the spent catalyst comprising coke deposits from the unstripped hydrocarbons, and
sending the spent catalyst comprising coke deposits to the catalyst regeneration unit through one or more conduits.

In one or more additional non-limiting illustrative embodiments, as may be combined with one or more of the preceding paragraphs, combusting the spent catalyst comprising the coke deposits comprises contacting the spent catalyst with an oxidizing stream in the catalyst regeneration unit.

In one or more additional non-limiting illustrative embodiments, as may be combined with one or more of the preceding paragraphs, the oxidizing stream is one of air, oxygen, methane or combinations thereof.

In one or more additional non-limiting illustrative embodiments, as may be combined with one or more of the preceding paragraphs, the first product effluent stream further comprises a C₂ to C₁₀ hydrocarbon product.

In one or more additional non-limiting illustrative embodiments, as may be combined with one or more of the preceding paragraphs, the first heated light hydrocarbon feed stream and the second heated light hydrocarbon feed stream are individually at a temperature of about 600° C. to about 1200° C.

In one or more additional non-limiting illustrative embodiments, as may be combined with one or more of the preceding paragraphs, the process further comprises flowing the second heated light hydrocarbon feed stream and the second heated regenerated catalyst upwards from the bottom portion of the riser to the reaction chamber in the top portion of the riser to crack the second heated light hydrocarbon feed stream in the presence of the second heated regenerated catalyst to produce a second product effluent stream comprising hydrogen and spent catalyst comprising coke deposits.

In one or more additional non-limiting illustrative embodiments, as may be combined with one or more of the preceding paragraphs, the process further comprises separating, in one or more cyclones, the spent catalyst from the first product effluent stream comprising hydrogen and spent catalyst comprising coke deposits, wherein the spent catalyst flows downward into the catalyst regeneration unit through one or more conduits.

In one or more additional non-limiting illustrative embodiments, as may be combined with one or more of the preceding paragraphs, the riser, the fluidized bed reactor and the catalyst regeneration unit each have an inner wall comprising a refractory material.

In one or more additional non-limiting illustrative embodiments, as may be combined with one or more of the preceding paragraphs, the first light hydrocarbon feed stream and the second light hydrocarbon feed stream each comprises C₁ to C₆ alkanes.

In one or more additional non-limiting illustrative embodiments, as may be combined with one or more of the preceding paragraphs, the first light hydrocarbon feed stream and the second light hydrocarbon feed stream each are a natural gas stream.

In one or more additional non-limiting illustrative embodiments, as may be combined with one or more of the preceding paragraphs, flowing the first heated light hydrocarbon feed stream and the first heated regenerated catalyst upwards from the bottom portion of the riser to a reaction chamber in a top portion of the riser further comprises flowing a third regenerated catalyst with the first heated light hydrocarbon feed stream and the first heated regenerated catalyst.

According to another aspect of the invention, a fluidized bed reactor system comprises:
a riser configured to receive a light hydrocarbon feed stream and a first regenerated catalyst in a bottom portion of the riser, the riser containing one or more heat sources in the bottom portion to heat the light hydrocarbon feed stream and the first regenerated catalyst to generate a heated light hydrocarbon feed stream and a heated regenerated catalyst, and a reaction chamber in a top portion of the riser in fluid communication with a fluidized bed reactor for cracking the heated light hydrocarbon feed stream in the presence of the heated regenerated catalyst flowing upwards from the bottom portion to produce a product effluent stream comprising hydrogen and spent catalyst comprising coke deposits, and
a catalyst regeneration unit operatively connected to the fluidized bed reactor and the riser, the catalyst regeneration unit being configured to receive the spent catalyst flowing downwards and combust the coke deposits to produce a second regenerated catalyst for sending to the bottom portion of the riser.

In one or more additional non-limiting illustrative embodiments, as may be combined with one or more of the preceding paragraphs, the riser further comprises a flow distributor located in the bottom portion and configured for flowing the light hydrocarbon feed stream and the first regenerated catalyst through the one or more heat sources and to the top portion of the riser.

In one or more additional non-limiting illustrative embodiments, as may be combined with one or more of the preceding paragraphs, the riser is operatively connected to one or more separators located in the fluidized bed reactor and configured to separate the spent catalyst from the product effluent stream comprising hydrogen and spent catalyst comprising coke deposits.

In one or more additional non-limiting illustrative embodiments, as may be combined with one or more of the preceding paragraphs, the fluidized bed reactor comprises a reactor stripper for receiving the spent catalyst separated from the product effluent stream flowing downward, the reactor stripper being configured to separate the spent catalyst from any unstripped hydrocarbons such that the separated spent catalyst flows downward to the catalyst regeneration unit and enters the catalyst regeneration unit through one or more conduits.

In one or more additional non-limiting illustrative embodiments, as may be combined with one or more of the preceding paragraphs, the riser, the fluidized bed reactor and the catalyst regeneration unit each comprises one or more layers of a refractory material.

In one or more additional non-limiting illustrative embodiments, as may be combined with one or more of the preceding paragraphs, the light hydrocarbon feed stream is a natural gas stream.

In one or more additional non-limiting illustrative embodiments, as may be combined with one or more of the preceding paragraphs, the fluidized bed reactor system is a retrofit of an existing fluidized bed reactor system.

In one or more additional non-limiting illustrative embodiments, as may be combined with one or more of the preceding paragraphs, the riser contains a first heat source and a second heat source in the bottom portion of the riser.

In one or more additional non-limiting illustrative embodiments, as may be combined with one or more of the preceding paragraphs, the riser is further configured to receive a third regenerated catalyst through an injection point located above the one or more heat sources.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

1.-20. (canceled)

21. A continuous process, comprising:
flowing, into a bottom portion of a riser in fluid communication with a fluidized bed reactor, a first regenerated catalyst and a first light hydrocarbon feed stream to contact with one or more heat sources to generate a first heated light hydrocarbon feed stream and a first heated regenerated catalyst;
flowing the first heated light hydrocarbon feed stream and the first heated regenerated catalyst upwards from the bottom portion of the riser to a reaction chamber in a top portion of the riser to crack the first heated light hydrocarbon feed stream in the presence of the first heated regenerated catalyst to produce a first product effluent stream comprising hydrogen and spent catalyst comprising coke deposits;
combusting, in a catalyst regeneration unit operatively connected to the fluidized bed reactor, the spent catalyst comprising the coke deposits to produce a second regenerated catalyst; and
flowing, into the bottom portion of the riser, the second regenerated catalyst and a second light hydrocarbon feed stream to contact with the one or more heat sources to generate a second heated light hydrocarbon feed stream and a second heated regenerated catalyst.

22. The continuous process according to claim 21, wherein flowing the first heated light hydrocarbon feed stream and the first heated regenerated catalyst upwards from the bottom portion of the riser in fluid communication with the fluidized bed reactor to the reaction chamber in the top portion of the riser utilizes a flow distributor.

23. The continuous process according to claim 21, wherein the riser is operatively connected to one or more separators in the fluidized bed reactor and the first product effluent stream comprising hydrogen and the spent catalyst comprising coke deposits are sent from the reaction chamber of the riser to the one or more separators.

24. The continuous process according to claim 23, wherein cracking the first heated light hydrocarbon feed stream in the presence of the first heated regenerated catalyst further produces unstripped hydrocarbons; and the process further comprises:
separating the first product effluent stream comprising hydrogen, the spent catalyst comprising coke deposits and the unstripped hydrocarbons in the separator;
flowing the spent catalyst comprising coke deposits and unstripped hydrocarbons downwards to a reaction stripper of the fluidized bed reactor;
stripping the spent catalyst comprising coke deposits from the unstripped hydrocarbons; and
sending the spent catalyst comprising coke deposits to the catalyst regeneration unit through one or more conduits.

25. The continuous process according to claim 24, wherein combusting the spent catalyst comprising the coke deposits comprises contacting the spent catalyst with an oxidizing stream in the catalyst regeneration unit.

26. The continuous process according to claim 25, wherein the oxidizing stream is one of air, oxygen, methane or combinations thereof.

27. The continuous process according to claim 21, wherein the first product effluent stream further comprises a C₂ to C₁₀ hydrocarbon product.

28. The continuous process according to claim 21, wherein the first heated light hydrocarbon feed stream and the second heated light hydrocarbon feed stream are individually at a temperature of about 600° C. to about 1200° C.

29. The continuous process according to claim 21, further comprising flowing the second heated light hydrocarbon feed stream and the second heated regenerated catalyst upwards from the bottom portion of the riser to the reaction chamber in the top portion of the riser to crack the second heated light hydrocarbon feed stream in the presence of the second heated regenerated catalyst to produce a second product effluent stream comprising hydrogen and the spent catalyst comprising coke deposits.

30. The continuous process according to claim 21, further comprising separating, in one or more cyclones, the spent catalyst from the first product effluent stream comprising hydrogen and the spent catalyst comprising coke deposits, wherein the spent catalyst flows downward into the catalyst regeneration unit through one or more conduits.

31. The continuous process according to claim 21, wherein the riser, the fluidized bed reactor and the catalyst regeneration unit each have an inner wall comprising a refractory material.

32. The continuous process according to claim 21, wherein the first light hydrocarbon feed stream and the second light hydrocarbon feed stream each comprises C₁ to C₆ alkanes.

33. The continuous process according to claim 21, wherein the first light hydrocarbon feed stream and the second light hydrocarbon feed stream each are a natural gas stream.

34. The continuous process according to claim 21, wherein flowing the first heated light hydrocarbon feed stream and the first heated regenerated catalyst upwards from the bottom portion of the riser to a reaction chamber in a top portion of the riser further comprises flowing a third regenerated catalyst with the first heated light hydrocarbon feed stream and the first heated regenerated catalyst.

35. A fluidized bed reactor system, comprising:
a riser configured to receive a light hydrocarbon feed stream and a first regenerated catalyst in a bottom portion of the riser, the riser comprising one or more heat sources in the bottom portion to heat the light hydrocarbon feed stream and the first regenerated catalyst to generate a heated light hydrocarbon feed stream and a heated regenerated catalyst, and a reaction chamber in a top portion of the riser in fluid communication with a fluidized bed reactor for cracking the heated light hydrocarbon feed stream in the presence of the heated regenerated catalyst flowing upwards from the bottom portion to produce a product effluent stream comprising hydrogen and spent catalyst comprising coke deposits; and
a catalyst regeneration unit operatively connected to the fluidized bed reactor and the riser, the catalyst regeneration unit being configured to receive the spent catalyst flowing downwards and combust the coke deposits to produce a second regenerated catalyst for sending to the bottom portion of the riser.

36. The fluidized bed reactor system according to claim 35, wherein the riser further comprises a flow distributor located in the bottom portion and configured for flowing the light hydrocarbon feed stream and the first regenerated catalyst through the one or more heat sources and to the top portion of the riser.

37. The fluidized bed reactor system according to claim 35, wherein the riser is operatively connected to one or more separators located in the fluidized bed reactor and configured to separate the spent catalyst from the product effluent stream comprising hydrogen and the spent catalyst comprising coke deposits.

38. The fluidized bed reactor system according to claim 37, wherein the fluidized bed reactor comprises a reactor stripper for receiving the spent catalyst separated from the product effluent stream flowing downward, the reactor stripper being configured to separate the spent catalyst from any unstripped hydrocarbons such that the separated spent catalyst flows downward to the catalyst regeneration unit and enters the catalyst regeneration unit through one or more conduits.

39. The fluidized bed reactor system according to claim 35, wherein the riser, the fluidized bed reactor and the catalyst regeneration unit each comprises one or more layers of a refractory material, and the light hydrocarbon feed stream is a natural gas stream.

40. The fluidized bed reactor system according to claim 35, wherein the fluidized bed reactor system is a retrofit of an existing fluidized bed reactor system.
